(19) United States
(12) Patent Application Publication
(10) Pub. No.: US 2024/0414277 A1
(43) Pub. Date: Dec. 12, 2024

(54) OPTICAL SCANNING DEVICE AND IMAGE FORMING APPARATUS INCLUDING THE SAME

(71) Applicant: KYOCERA Document Solutions Inc., Osaka (JP)

(72) Inventor: Yoshihito HARIBA, Osaka (JP)

(73) Assignee: KYOCERA Document Solutions Inc., Osaka (JP)

(21) Appl. No.: 18/731,920

(22) Filed: Jun. 3, 2024

(30) Foreign Application Priority Data
Jun. 7, 2023 (JP) 2023-093861

(51) Int. Cl. H04N 1/113; G02B 26/10; G03G 15/043

(52) U.S. Cl. CPC H04N 1/1135; G02B 26/105; G03G 15/0435

(57) ABSTRACT

The casing houses the scanning optical system, and includes a holding portion holding an optical element configuring the scanning optical system. The pressing holding member presses and holds the optical element to the holding portion. The pressing holding member includes a body portion and a pressing portion. The pressing portion is coupled to the body portion, and presses the optical element held by the holding portion, against the holding portion. The casing includes a support portion provided to face the holding portion and supporting the body portion. The support portion is disposed on a peripheral edge of a through hole penetrating through the casing, and includes a support protrusion. The support protrusion protrudes from an outer surface to come into contact with a peripheral edge of the body portion. The through hole is an emission port emitting the laser beam to outside of the casing.

### INCORPORATION BY REFERENCE

This application is based on and claims the benefit of priority from Japanese Patent Application No. 2023-093861 filed on Jun. 7, 2023, the contents of which are hereby incorporated by reference.

### BACKGROUND

The present disclosure relates to an optical scanning device forming a latent image on a scanned surface by exposure scanning, and to an imaging apparatus including the optical scanning device, such as a copier, a printer, a facsimile, and a multifunctional peripheral thereof.

An existing optical scanning device includes a scanning optical system that performs scanning with a laser beam and guides the laser beam to an image carrier, a casing, and a pressing holding member, and exposes a surface of the image carrier to form an electrostatic latent image having attenuated charges. The casing houses the scanning optical system, and includes a holding portion holding an optical element configuring the scanning optical system. The pressing holding member presses and holds the optical element to the holding portion. The casing includes a support portion that is provided to face the holding portion and supports the pressing holding member. The pressing holding member is inserted into a through hole penetrating through the casing.

In a case where the existing technique is adopted, dusts may enter inside of the casing from the through hole. Therefore, it is necessary to newly provide a member closing the through hole, which causes an issue that a manufacturing cost of the optical scanning device is increased.

The present disclosure is made to solve the above-described issue, and is directed to an optical scanning device that can stably hold an optical element while suppressing increase in manufacturing cost, and an image forming apparatus including the optical scanning device.

### SUMMARY

An optical scanning device according to one aspect of the present disclosure includes a scanning optical system, a casing, and a pressing holding member, and exposes a surface of an image carrier to form an electrostatic latent image having attenuated charges. The scanning optical system performs scanning with a laser beam and guides the laser beam to the image carrier. The casing houses the scanning optical system, and includes a holding portion holding an optical element configuring the scanning optical system. The pressing holding member presses and holds the optical element to the holding portion. The pressing holding member includes a body portion and a pressing portion. The pressing portion is coupled to the body portion, and presses the optical element held by the holding portion, against the holding portion. The casing includes a support portion provided to face the holding portion and supporting the body portion. The support portion is disposed on a peripheral edge of a through hole penetrating through the casing, and includes a support protrusion. The support protrusion protrudes from an outer surface to come into contact with a peripheral edge of the body portion. The through hole is an emission port emitting the laser beam to outside of the casing.

An optical scanning device according to another aspect of the present disclosure includes a scanning optical system, a casing and a pressing holding member, and exposes a surface of an image carrier to form an electrostatic latent image having attenuated charges. The scanning optical system performs scanning with a laser beam and guides the laser beam to the image carrier. The casing houses the scanning optical system, and includes a holding portion holding an optical element configuring the scanning optical system. The pressing holding member presses and holds the optical element to the holding portion. The pressing holding member includes a body portion and a pressing portion. The pressing portion is coupled to the body portion, and presses the optical element held by the holding portion, against the holding portion. The casing includes a support portion provided to face the holding portion and supporting the body portion. The support portion is disposed on a peripheral edge of a through hole penetrating through the casing, and includes a support protrusion. The support protrusion protrudes from an outer surface to come into contact with a peripheral edge of the body portion. The casing includes a housing portion including an opened upper surface and internally housing the scanning optical system, and a lid portion covering the upper surface of the housing portion. Each of the housing portion and the lid portion includes a wall portion surrounding the scanning optical system from sides. The through hole is provided on the wall portion of one of the housing portion and the lid portion, and is closed by the wall portion of the other of the housing portion and the lid portion.

This and other objects of the present disclosure, and the specific benefits obtained according to the present disclosure, will become apparent from the description of embodiments which follows.

### BRIEF DESCRIPTION OF THE DRAWINGS

FIG. 1 is a schematic cross-sectional view illustrating an entire configuration of an image forming apparatus 100 mounted with an optical scanning device 5 according to the present disclosure;

FIG. 2 is a perspective view of the optical scanning device 5 according to an embodiment of the present disclosure;

FIG. 3 is a perspective view of the optical scanning device 5 according to the embodiment of the present disclosure;

FIG. 4 is a cross-sectional view taken along line A-A in FIG. 2;

FIG. 5 is a perspective view of a pressing spring 50 pressing and holding a reflection mirror 49b inside a casing 48 of the optical scanning device 5 according to the present disclosure;

FIG. 6 is a partial cross-sectional view of a vicinity of the reflection mirror 49b inside the casing 48 of the optical scanning device 5 according to the present disclosure;

FIG. 7 is a perspective view of a pressing spring 80 pressing and holding a reflection mirror 49a inside the casing 48 of the optical scanning device 5 according to the present disclosure;

FIG. 8 is a cross-sectional view taken along line B-B in FIG. 2;

FIG. 9 is a partial cross-sectional view of a vicinity of the reflection mirror 49a inside the casing 48 of the optical scanning device 5 according to the present disclosure; and

FIG. 10 is a partial cross-sectional view illustrating a modification of the vicinity of the reflection mirror 49b inside the casing 48 of the optical scanning device 5 according to the present disclosure.

### DETAILED DESCRIPTION

### [1. Configuration of Image Forming Apparatus 100]

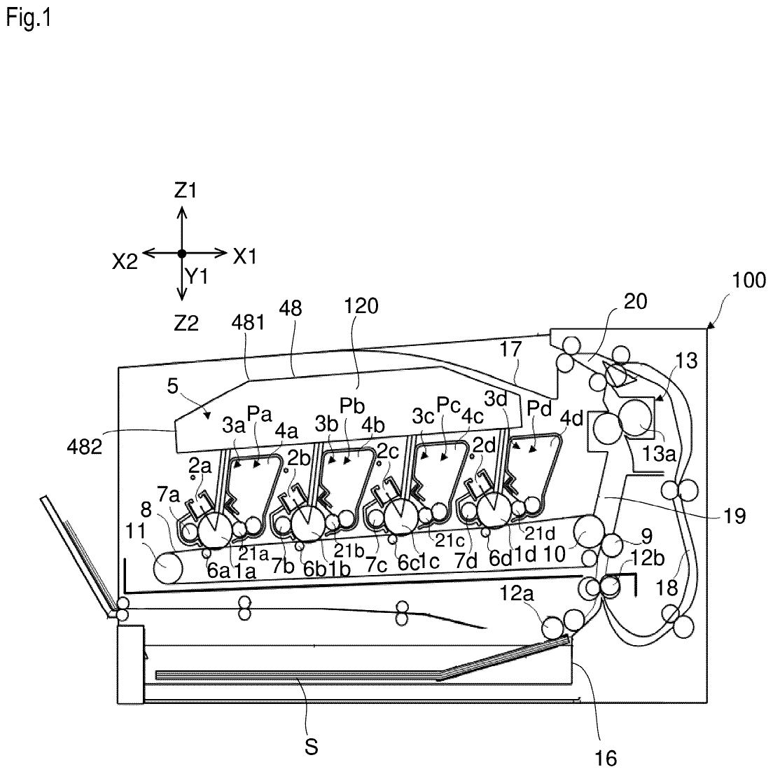

An embodiment of the present disclosure is described below with reference to drawings. FIG. 1 is a schematic cross-sectional view illustrating an entire configuration of an image forming apparatus 100 mounted with an optical scanning device 5 according to the present disclosure. For convenience of description, in an installation state where the image forming apparatus 100 is usable (state illustrated in FIG. 1), a vertical direction is defined as an up-down direction (Z1-Z2 direction). Further, a front-rear direction (Y1-Y2 direction) is defined while a surface of the image forming apparatus 100 on a front side of a paper surface illustrated in FIG. 1 is regarded as a front surface. A right-left direction (X1-X2) direction is defined with the front surface of the image forming apparatus 100 in the installation state as a reference. In the present embodiment, the right-left direction (X1-X2 direction) is orthogonal to the up-down direction (Z1-Z2 direction) and the front-rear direction (Y1-Y2 direction).

The image forming apparatus 100 is a tandem color printer. The image forming apparatus 100 includes, as image carriers, rotatable photosensitive drums 1a to 1d. An organic photosensitive body (OPC photosensitive body) including an organic photosensitive layer, an amorphous silicon photosensitive body including an amorphous silicon photosensitive layer, or the like is used for each of the photosensitive drums 1a to 1d. The photosensitive drums 1a to 1d are tandem-arranged corresponding to respective colors of yellow, cyan, magenta, and black.

A development device 3a, a charger 2a, and a cleaning device 7a are disposed around the photosensitive drum 1a. Likewise, development devices 3b to 3d, chargers 2b to 2d, and cleaning devices 7b to 7d are respectively disposed around the photosensitive drums 1b to 1d. The optical scanning device 5 is disposed on an upper side Z1 of the development devices 3a to 3d.

The development devices 3a to 3d are respectively disposed on right sides X1 of the photosensitive drums 1a to 1d. The development devices 3a to 3d respectively face the photosensitive drums 1a to 1d, and respectively supply toner to the photosensitive drums 1a to 1d. The development devices 3a to 3d respectively include containers 4a to 4d, and the toner of the respective colors of magenta, cyan, yellow, and black are housed in the containers 4a to 4d.

The chargers 2a to 2d are respectively disposed on upstream sides of the development devices 3a to 3d in rotation directions of the photosensitive drums 1a to 1d, and respectively face surfaces of the photosensitive drums 1a to 1d. The chargers 2a to 2d respectively uniformly charge the surfaces of the photosensitive drums 1a to 1d.

In the present embodiment, the optical scanning device 5 is disposed on the upper side Z1 of the photosensitive drums 1a to 1d. The optical scanning device 5 applies light to (performs optical scanning on) the surfaces of the photosensitive drums 1a to 1d uniformly charged by the chargers 2a to 2d, based on image data such as characters and patterns input from a personal computer or the like to an image input unit. As a result, electrostatic latent images are formed on the surfaces of the photosensitive drums 1a to 1d.

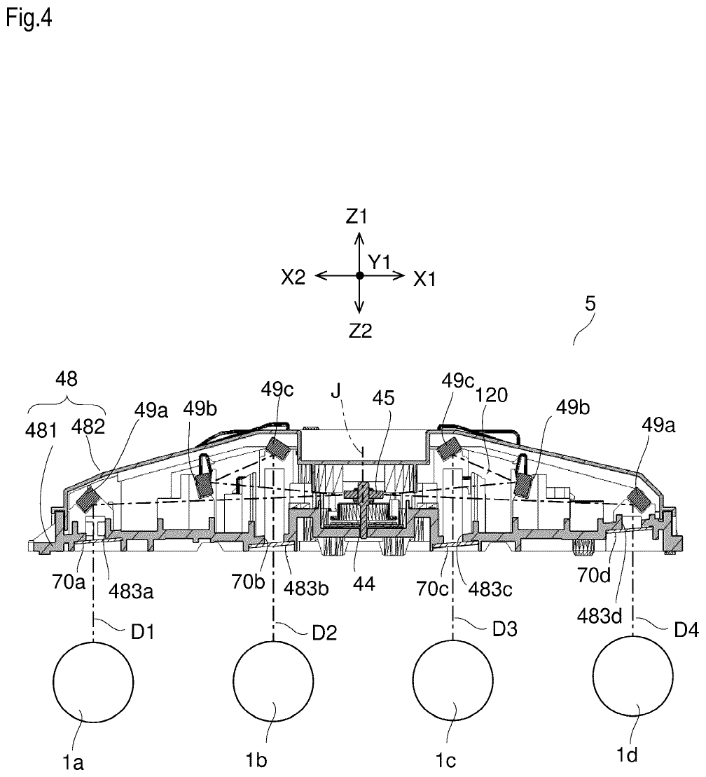

A casing 48 of the optical scanning device 5 is a resin molded product, and includes a housing portion 481 in which one surface (upper surface in present embodiment) is open, and a lid portion 482 covering the opening (see FIG. 4). The housing portion 481 houses a scanning optical system 120.

Laser beams D1 to D4 are respectively applied to the surfaces of the photosensitive drums 1a to 1d from downstream sides of the chargers 2a to 2d in the rotation directions of the photosensitive drums 1a to 1d. As a result, electrostatic latent images are formed on the surfaces of the photosensitive drums 1a to 1d. These electrostatic latent images are developed to toner images by the development devices 3a to 3d. The optical scanning device 5 is described in detail below.

An endless intermediate transfer belt 8 is stretched on a driving roller 10 and a driven roller 11. When the driving roller 10 is rotated by a motor (not illustrated), the intermediate transfer belt 8 is circularly driven in a clockwise direction in FIG. 1.

The photosensitive drums 1a to 1d are arranged adjacent to one another along a conveyance direction (X1-X2 direction) on the upper side Z1 of the intermediate transfer belt 8. Further, the photosensitive drums 1a to 1d are in contact with the intermediate transfer belt 8.

Primary transfer rollers 6a to 6d respectively face the photosensitive drums 1a to 1d with the intermediate transfer belt 8 in between. The primary transfer rollers 6a to 6d are brought into pressure contact with the intermediate transfer belt 8 and form primary transfer portions with the photosensitive drums 1a to 1d. The toner images are transferred to the intermediate transfer belt 8 in the primary transfer portions.

More specifically, primary transfer voltages are applied to the primary transfer rollers 6a to 6d, and the toner images on the photosensitive drums 1a to 1d are accordingly sequentially transferred to the intermediate transfer belt 8 at predetermined timings. As a result, a full color toner image in which the toner images of four colors of magenta, cyan, yellow, and black are superimposed with predetermined positional relationship is formed on a surface of the intermediate transfer belt 8.

A secondary transfer roller 9 faces the driving roller 10 with the intermediate transfer belt 8 in between. The secondary transfer roller 9 is brought into pressure contact with the intermediate transfer belt 8, and forms a secondary transfer portion with the driving roller 10. In the secondary transfer portion, when a secondary transfer voltage is applied to the secondary transfer roller 9, the toner image on the surface of the intermediate transfer belt 8 is transferred to a sheet S. After the toner image is transferred, a belt cleaning device (not illustrated) cleans the toner remaining on the intermediate transfer belt 8.

A sheet feeding cassette 16 is disposed at a lower part in the image forming apparatus 100. The sheet feeding cassette 16 can store a plurality of sheets S. A sheet conveyance path 19 is disposed on a right side X1 of the sheet feeding cassette 16.

The sheet conveyance path 19 conveys the sheet S delivered from the sheet feeding cassette 16 to the secondary transfer portion. A fixing unit 13 and a sheet conveyance path 20 are disposed at a right upper part in the image forming apparatus 100. The fixing unit 13 performs fixing processing on the sheet S on which an image has been formed. The sheet conveyance path 20 conveys the sheet S subjected to the fixing processing, to a sheet discharge portion 17.

The sheets S stored in the sheet feeding cassette 16 are delivered one by one by a pickup roller 12a to the sheet conveyance path 19 side.

A registration roller pair 12b conveys the sheet S to the secondary transfer portion by adjusting a timing of image forming operation on the intermediate transfer belt 8 and a timing of operation for feeding the sheet to the secondary transfer portion. The full color toner image on the intermediate transfer belt 8 is secondarily transferred to the sheet S conveyed to the secondary transfer portion by the secondary transfer roller 9 receiving the secondary transfer voltage. The sheet S to which the full color toner image has been transferred is conveyed to the fixing unit 13.

The fixing unit 13 includes a fixing belt heated by a heater, a fixing roller in contact with an inner surface of the fixing belt, a pressure roller brought into pressure contact with the fixing roller with the fixing belt in between, and the like. The fixing unit 13 heats and pressurize the sheet S to which the toner image has been transferred. As a result, the fixing processing is performed. The sheet S to which the toner image has been fixed by the fixing unit 13 is turned over in a sheet conveyance path 18 as necessary. Thereafter, the sheet S is again conveyed to the secondary transfer portion through the registration roller pair 12b, and a new toner image is then secondarily transferred to a rear surface of the sheet S by the secondary transfer roller 9 and is fixed by the fixing unit 13. The sheet S to which the toner image has been fixed is discharged to the sheet discharge portion 17 through the sheet conveyance path 20.

[2. Configuration of Optical Scanning Device]

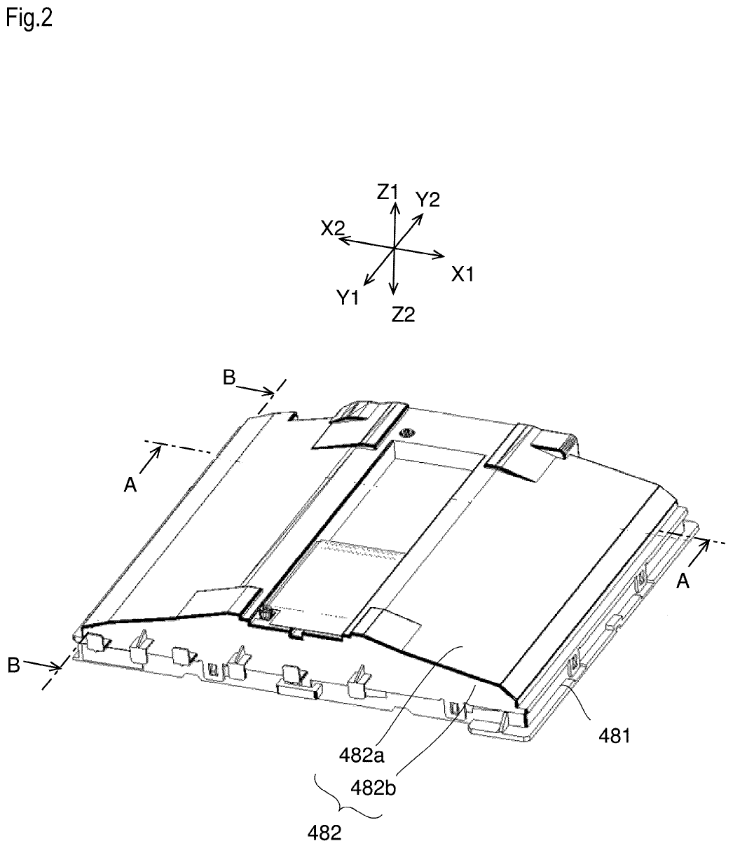

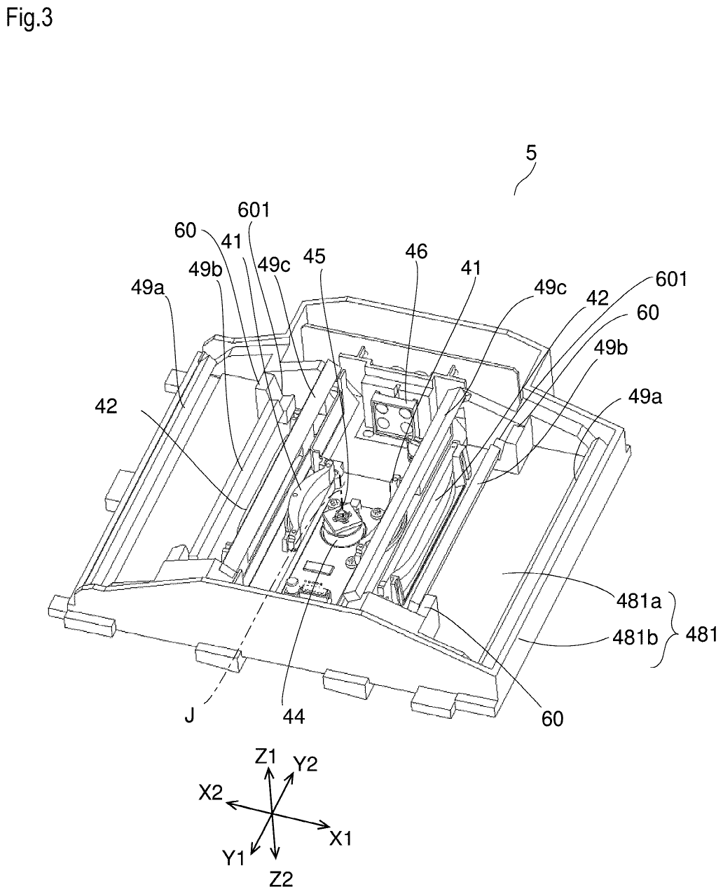

FIG. 2 and FIG. 3 are perspective views of the optical scanning device 5. FIG. 3 illustrates a state where the lid portion 482 is removed. FIG. 4 is a cross-sectional view taken along line A-A in FIG. 2. A part in FIG. 4 schematically illustrates configurations of members, and does not strictly illustrate shapes and positional relationship of the members. Further, in FIG. 4, first scanning lenses 41 and second scanning lenses 42 are not illustrated.

In the following description, a main scanning direction (Y1-Y2 direction) is a longitudinal direction of reflection mirrors 49a to 49c. The main scanning direction (Y1-Y2 direction) is also coincident with an extending direction of rotation axes of the photosensitive drums 1a to 1d and the front-rear direction of the image forming apparatus 100. A sub-scanning direction (Z1-Z2 direction) is a direction parallel to a rotation axis J of a polygon mirror 45, and is coincident with the up-down direction of the image forming apparatus 100. The right-left direction (X1-X2 direction) is a direction orthogonal to the main scanning direction (Y1-Y2 direction) and the sub-scanning direction (Z1-Z2 direction), and is coincident with a parallel direction of the reflection mirrors 49a to 49c.

The optical scanning device 5 outputs (applies) a plurality of (four in present embodiment) laser beams D1 to D4 modulated based on respective image signals, to the photosensitive drums 1a to 1d, to expose the surfaces of the photosensitive drums 1a to 1d, thereby forming electrostatic latent images having attenuated charges.

The optical scanning device 5 includes a light source unit 46, the polygon mirror 45, paired first scanning lenses 41, paired second scanning lenses 42, paired reflection mirrors 49a, paired reflection mirrors 49b, paired reflection mirrors 49c, and the casing 48.

The casing 48 includes the housing portion 481 and the lid portion 482. The housing portion 481 is formed in a substantially quadrangular shape in a top view. The housing portion 481 houses the light source unit 46, the polygon mirror 45, the paired first scanning lenses 41, the paired second scanning lenses 42, the paired reflection mirrors 49a, the paired reflection mirrors 49b, and the paired reflection mirrors 49c. The polygon mirror 45, the first scanning lenses 41, the second scanning lenses 42, and the reflection mirrors 49a to 49c configure the scanning optical system 120 that performs scanning with the laser beams D1 to D4 and guides the laser beams D1 to D4 to the photosensitive drums (image carriers) 1a to 1d.

The housing portion 481 includes a bottom wall portion 481a and a peripheral wall portion 481b. The bottom wall portion 481a expands in a direction orthogonal to the rotation axis J of the polygon mirror 45. The bottom wall portion 481a includes emission ports 483a to 483d each penetrating through the bottom wall portion 481a in the top-down direction (see FIG. 4). The emission ports 483a to 483d extend in the main scanning direction (Y1-Y2 direction). The laser beams D1 to D4 emitted from the scanning optical system 120 are emitted to outside of the casing 48 through the emission ports 483a to 483d, and enter the corresponding photosensitive drums 1a to 1d. The emission ports 483a to 483d are respectively covered with dustproof glasses 70a to 70d. This makes it possible to prevent dusts from entering the inside of the casing 48.

The peripheral wall portion 481b extends upward from an outer peripheral part of the bottom wall portion 481a, and surrounds the light source unit 46, the polygon mirror 45, the paired first scanning lenses 41, the paired second scanning lenses 42, the paired reflection mirrors 49a, the paired reflection mirrors 49b, and the paired reflection mirrors 49c from sides.

The lid portion 482 includes a top surface portion 482a and a peripheral surface portion 482b. The top surface portion 482 covers the opened upper surface of the housing portion 481. The peripheral surface portion 482b extends downward from an outer peripheral part of the top surface portion 482a, and covers a part of the peripheral wall portion 481b from outside in a radial direction. In other words, the housing portion 481 and the lid portion 482 respectively include the wall portions 481b and 482b surrounding the scanning optical system 120 from sides.

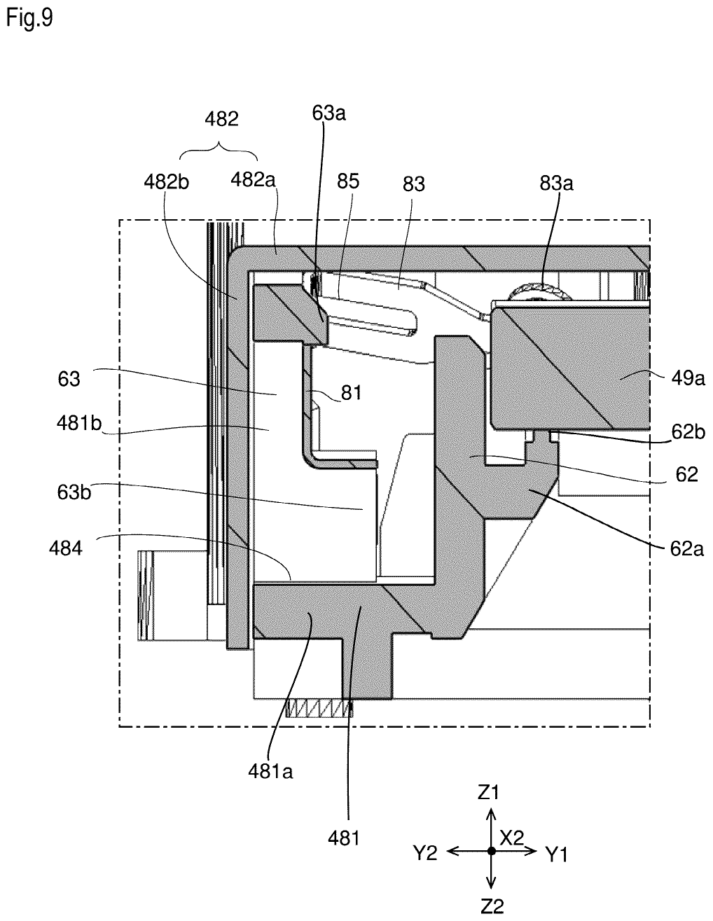

In the present embodiment, the peripheral wall portion 481b includes through holes 484 penetrating through the peripheral wall portion 481b in the main scanning direction (Y1-Y2 direction) on one side (Y2 side) in the main scanning direction at both end parts in the right-left direction (X1-X2 direction). The through holes 484 are covered with the peripheral surface portion 482b (see FIG. 9). In other words, the through holes 484 are provided in the wall portion 481b of one of the housing portion 481 and the lid portion 482, and are closed by the wall portion 482b of the other of the housing portion 481 and the lid portion 482. This makes it possible to prevent dusts from entering the inside of the casing 48. Note that configurations in vicinities of the through holes 484 are described in detail below.

The light source unit 46 includes light emission modules (not illustrated), collimator lenses (not illustrated), and cylindrical lenses (not illustrated). The light emission modules emit the respective laser beams D1 to D4 corresponding to the colors Y (yellow), C (cyan), M (magenta), and K (black). The laser beams D1 to D4 emitted from the respective light emission modules are applied to the polygon mirror 45 through the collimator lenses and the cylindrical lenses.

At this time, the collimator lenses (not illustrated) convert the laser beams D1 to D4 emitted from the light emission modules, into substantially parallel light beams in a main scanning cross-section. The cylindrical lenses (not illustrated) converge the laser beams D1 to D4 in the sub-scanning direction (Z1-Z2 direction), and converge the laser beams D1 to D4 to vicinities of deflection surfaces (reflection surfaces) of the polygon mirror 45. As a result, the laser beams D1 to D4 form line images in the vicinities of the deflection surfaces of the polygon mirror 45.

The polygon mirror 45 includes a regular-polygonal rotary polygon mirror having a plurality of deflection surfaces (reflection surfaces) on side surfaces, and is rotated around the rotation axis J at a predetermined speed by a polygon motor 44. The polygon motor 44 is fixed to the bottom wall portion 481a of the housing portion 481.

The polygon mirror 45 includes the plurality of reflection surfaces. In the present embodiment, the polygon mirror 45 is a polygon mirror formed in a quadrilateral prism shape. The laser beams D1 and D2 having entered the polygon mirror 45 are deflected by optional reflection surfaces rotationally driven, reflected by the reflection surfaces of the polygon mirror 45 to the left direction (X2 direction), and guided to the corresponding first scanning lens 41 and the corresponding second scanning lens 42. The laser beams D1 and D2 are reflected to the left side X2 of the rotation axis J of the polygon mirror 45. On the other hand, the laser beams D3 and D4 having entered the polygon mirror 45 are deflected by optional reflection surfaces rotationally driven, reflected by the reflection surfaces of the polygon mirror 45 to the right direction (X1 direction), and guided to the corresponding first scan lens 41 and the corresponding second scanning lens 42 (see FIG. 3).

The second scanning lenses 42 are disposed on downstream sides of the respective first scanning lenses 41 in the optical paths of the laser beams D1 to D4.

Each of the first scanning lenses 41 is a lens including distortion aberration (f characteristics), and is a long lens extending along the main scanning direction (Y1-Y2 direction). The first scanning lenses 41 condense the laser beams D1 to D4 reflected by the deflection surfaces of the polygon mirror 45.

As with the first scanning lenses 41, each of the second scanning lenses 42 is a lens including distortion aberration (fθ characteristics), and is a long lens extending along the main scanning direction (Y1-Y2 direction). The second scanning lenses 42 condense the laser beams D1 to D4 having passed through the first scanning lenses 41, and causes the laser beams D1 to D4 to form images on scanned surfaces of the photosensitive drums 1a to 1d.

The paired reflection mirrors 49a reflect the laser beams D1 and D4. The paired reflection mirrors 49b and the paired reflection mirrors 49c reflect the laser beams D2 and D3.

The laser beam D1 condensed by the corresponding first scanning lens 41 and the corresponding second scanning lens 42 is reflected by the corresponding reflection mirror 49a, and forms an image on the scanned surface of the photosensitive drum 1a. The laser beam D4 condensed by the corresponding first scanning lens 41 and the corresponding second scanning lens 42 is reflected by the corresponding reflection mirror 49a, and forms an image on the scanned surface of the photosensitive drum 1d.

The laser beam D2 condensed by the corresponding first scanning lens 41 and the corresponding second scanning lens 42 is reflected by the corresponding reflection mirrors 49b and 49c, and forms an image on the scanned surface of the photosensitive drum 1b. The laser beam D3 condensed by the corresponding first scanning lens 41 and the corresponding second scanning lens 42 is reflected by the corresponding reflection mirrors 49b and 49c, and forms an image on the scanned surface of the photosensitive drum 1c.

The laser beams D1 to D4 reflected and deflected by the polygon mirror 45 pass through the first scanning lenses 41 and the second scanning lenses 42, and are respectively condensed on the scanned surfaces of the photosensitive drums 1a to 1d. As a result, beam spots are formed on the scanned surfaces of the photosensitive drums 1a to 1d. Further, the scanned surfaces of the photosensitive drums 1a to 1d are respectively scanned with the laser beams D1 to D4 condensed on the scanned surfaces of the photosensitive drums 1a to 1d at constant speeds.

At this time, by rotation of the polygon mirror 45, the scanned surfaces (peripheral surfaces) of the photosensitive drums (image carriers) 1a to 1d are scanned with the laser beams D1 to D4 in the main scanning direction (Y1-Y2 direction). Further, by rotation of the photosensitive drums 1a to 1d, the scanned surfaces of the photosensitive drums 1a to 1d are scanned with the laser beams D1 to D4 in the sub-scanning direction (Z1-X2 direction), and the electrostatic latent images are formed on the surfaces of the photosensitive drums 1a to 1d.

[3. Attachment Configuration of Reflection Mirror 49b]

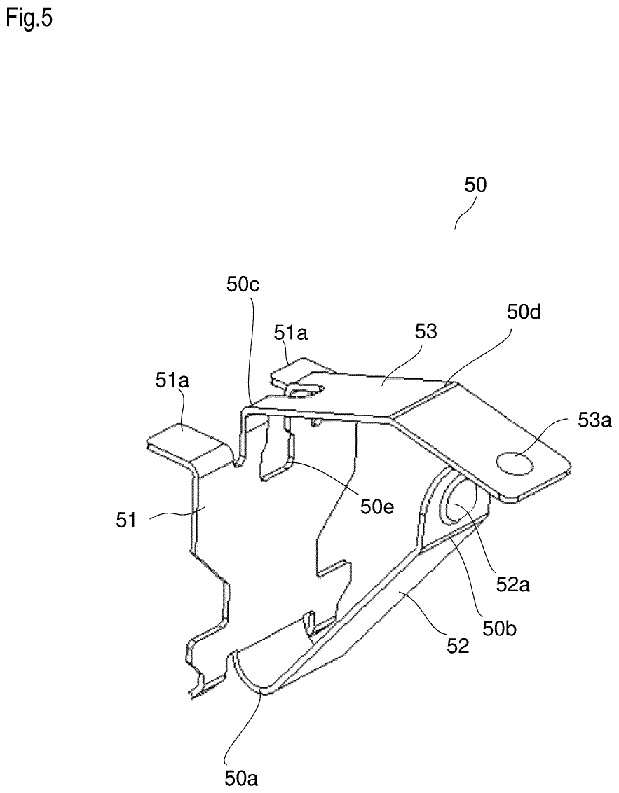

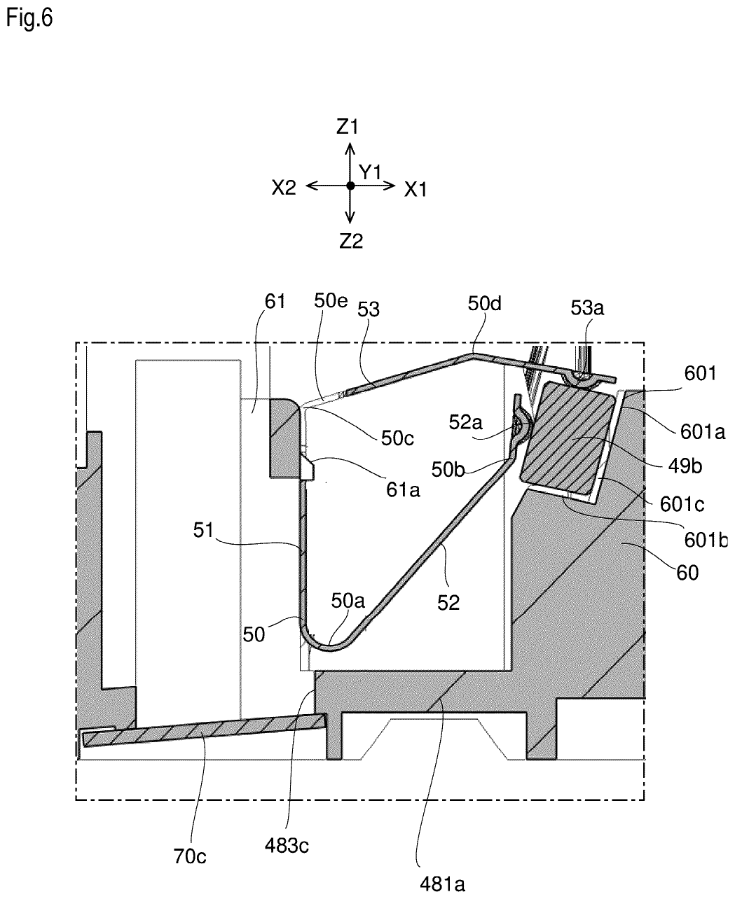

FIG. 5 is a perspective view of a pressing spring 50 (pressing holding member) pressing and holding one reflection mirror 49b, and FIG. 6 is a partial cross-sectional view illustrating a vicinity of one reflection mirror 49b in an enlarged manner and illustrates a holding structure on one end side (Y2 side) of one reflection mirror 49b in a longitudinal direction.

The housing portion 481 includes mirror holding portions (holding portions) 60 and first spring support portions (support portions) 61 (see FIG. 6). The mirror holding portions 60 and the first spring support portions 61 protrude upward (in Z1 direction) from an upper surface of the bottom wall portion 481a. The mirror holding portions 60 are disposed at two positions on both end parts of the bottom wall portion 481a in the main scanning direction (Y1-Y2 direction), namely, are provided at four positions in total (see FIG. 3). In other words, the casing 48 includes the mirror holding portions (holding portions) 60 holding the reflection mirrors (optical elements) 49b configuring the scanning optical system 120.

Each of the mirror holding portions 60 includes a concave part 601 that is an upper surface recessed downward. The concave part 601 includes a first holding surface 601a and a second holding surface 601b. The first holding surface 601a faces a light reflection surface of the corresponding reflection mirror 49b in the right-left direction (X1-X2 direction). The second holding surface 601b faces a lower surface of the corresponding reflection mirror 49b in the top-down direction (Z1-Z2 direction).

The first spring support portions 61 are disposed adjacent to one sides (Y2 sides) of the emission ports 483b and 483c in the longitudinal direction, and are provided at two positions in total. Each of the first spring support portions 61 includes a support protrusion 61a. The support protrusions 61a protrude from side surfaces of the respective first spring support portions 61 in the right-left direction (X1-X2 direction) (see FIG. 6).

In other words, the casing 48 includes the first spring support portions (support portions) 61. The first spring support portions 61 are provided to face the mirror holding portions 60, and support spring body portions (body portions) 51 of the pressing springs 50 described below. The first spring support portions (support portions) 61 are disposed on peripheral edges of the respective through holes 483b and 483c penetrating through the casing 48, and include the support protrusions 61a.

The support protrusions 61a protrude from outer surfaces of the respective first spring support portions (support portions) 61. In the present embodiment, the support protrusions 61a extend in directions approaching the corresponding mirror holding portions 60. At this time, the through holes 483b and 483c facing the respective support protrusions 61a are emission ports 483b and 483c emitting the laser beams D2 and D3 to the outside of the casing 48.

Front ends of the support protrusions 61a are positioned inside the respective emission ports 483b and 483c in a cross-section orthogonal to the longitudinal direction (Y1-Y2 direction) of the reflection mirrors 49b.

The both ends of the reflection mirrors 49b in the longitudinal direction (both ends in Y1-Y2 direction) are held by the mirror holding portions 60 (see FIG. 3). The reflection mirrors 49b are fixed inside the concave portions 601 with adhesives 601c. Further, one end parts (on Y2 side) of the reflection mirrors 49b in the longitudinal direction are pressed by the pressing springs 50. The pressing springs 50 are supported by the first spring support portions 61, and the reflection mirrors 49b are stably held to the housing portion 481.

More specifically, each of the pressing springs (pressing holding members) 50 is formed by bending a metal plate, and includes a spring body portion (body portion) 51, a first pressing portion (pressing portion) 52, and a second pressing portion (pressing portion) 53.

Paired claws 51a are provided at an upper end part of the spring body portion 51 with the second pressing portion 53 in between. The claws 51a are bent in a direction separating from the second pressing portion 53. When the spring body portion 51 is supported by the corresponding first spring support portion 61 (see FIG. 6), the claws 51a are disposed on an upper surface of the first spring support portion 61, which causes the own pressure spring 50 to be stably supported by the first spring support portion 61.

The first pressing portion 52 is continuously provided at a lower end part of the spring body portion 51 through a first bent part 50a. The first pressing portion 52 extends while being inclined upward as separating from the spring body portion 51. A front end part of the first pressing portion is bent upward (in Z1 direction) at a second bent part 50b. The first pressing portion 52 is coupled to the spring body portion 51 so as to be elastically deformable with the first bent part 50a as a bending fulcrum. A hemispherical first pressing contact 52a is provided at the front end part of the first pressing portion 52 (front end side beyond second bent part 50b).

The second pressing portion 53 is continuously provided at the upper end part of the spring body portion 51 through a third bent part 50c. The second pressing portion 53 extends from the spring body portion 51 in the same direction as the extending direction of the first pressing portion 52. A front end part of the second pressing portion 53 is bent at a fourth bent part 50d in an inverse V-shape in a side view. The second pressing portion 53 is coupled to the spring body portion 51 so as to be elastically deformable with the third bent part 50c as a bending fulcrum. A hemispherical second pressing contact 53a is provided at the front end part of the second pressing portion 53 (front end side beyond third bent part 50d).

Each of the pressing springs 50 includes a slit 50e extending over the upper end part of the spring body portion 51 and a root part of the second pressing portion 53.

Each of the pressing springs 50 is inserted between the light reflection surface of the corresponding reflection mirror 49b and the corresponding first spring support portion 61. At this time, lower ends of the slits 50e abut on the respective support protrusions 61a. In other words, the support protrusions 61a come into contact with peripheral edges of the respective spring body portions (body portions) 51. As a result, the pressing springs 50 are easily positioned to the respective first spring support portions 61. The first pressing portions 52 are in contact with the light reflection surfaces of the respective reflection mirrors 49b at the first pressing contacts 52a. The second pressing portions 53 are in contact with upper surfaces of the respective reflection mirrors 49b at the second pressing contacts 53a.

As a result, the reflection mirrors 49b are pressed against the first holding surfaces 601a by urging force of the first pressing portions 52 of the respective pressing springs 50. Further, the reflection mirrors 49b are pressed against the second holding surfaces 601b by urging force of the second pressing portions 53 of the respective pressing springs 50. In other words, the first pressing portions (pressing portions) 52 and the second pressing portions (pressing portions) 53 press the reflection mirrors (optical elements) 49b held by the mirror holding portions (holding portions) 60 against the mirror holding portions (holding portions) 60.

With this configuration, each of the reflection mirrors 49b can be held to the first holding surfaces 601a and the second holding surfaces 601b of the corresponding mirror holding portions 60 by using one pressing spring 50. This makes it possible to stably hold the reflection mirrors 49b without increasing the number of pressing springs 50.

When the housing portion 481 is formed by sandwiching a resin with dies in the top-down direction (Z1-Z2 direction), the emission ports 483b and 483c can be used as die removing holes. This makes it possible to easily form the support protrusions 61a. Using the emission ports 483b and 483c provided on the optical axes of the laser beams D2 and D3 eliminates necessity for formation of new through holes for forming the support protrusions 61a in the casing 48. Further, the emission ports 483b and 483c are respectively covered with the dustproof glasses 70b and 70c, which eliminates necessity for arrangement of new members covering the through holes. Accordingly, it is possible to provide the optical scanning device 5 that can stably hold the reflection mirrors (optical elements) 49b while suppressing increase in manufacturing cost, and the image forming apparatus 100 including the optical scanning device 5.

The front ends of the support protrusions 61a are positioned inside the respective emission ports 483b and 483c in the cross-section orthogonal to the longitudinal direction (Y1-Y2 direction) of the reflection mirrors 49b. Therefore, the support protrusions 61a can be more easily formed by using the emission ports 483b and 483c as the die removing holes.

Note that the front ends of the support protrusions 61a may be bent in directions approaching the respective through holes 483b and 483c. As a result, the front ends of the support protrusions 61a can be locked to the lower ends of the respective slits 50c. In other words, the support protrusions 61a are locked to the peripheral edges of the respective spring body portions (body portions) 51. Accordingly, the pressing springs 50 are stably supported to the respective first spring support portions (support portions) 61. Even in a case where the front ends of the support protrusions 61a are bent, the support protrusions 61a can be more easily formed by using the emission ports 483b and 483c as the die removing holes.

[4. Attachment Configuration of Reflection Mirror 49a]

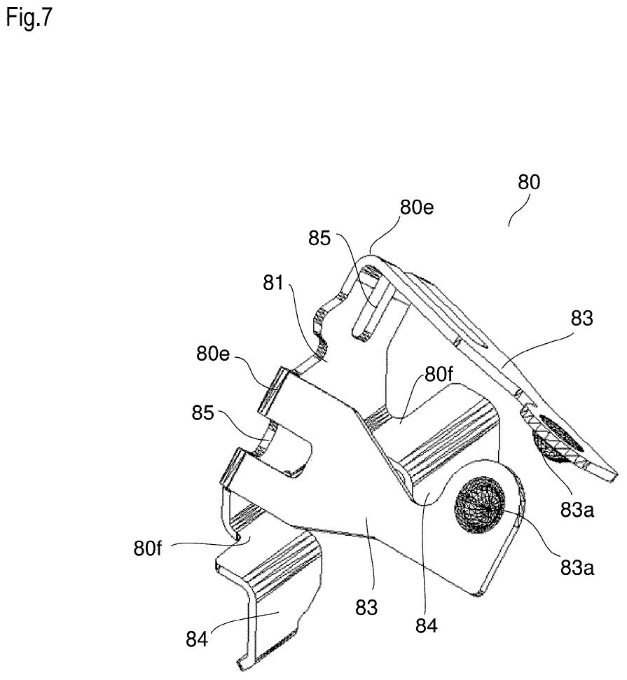

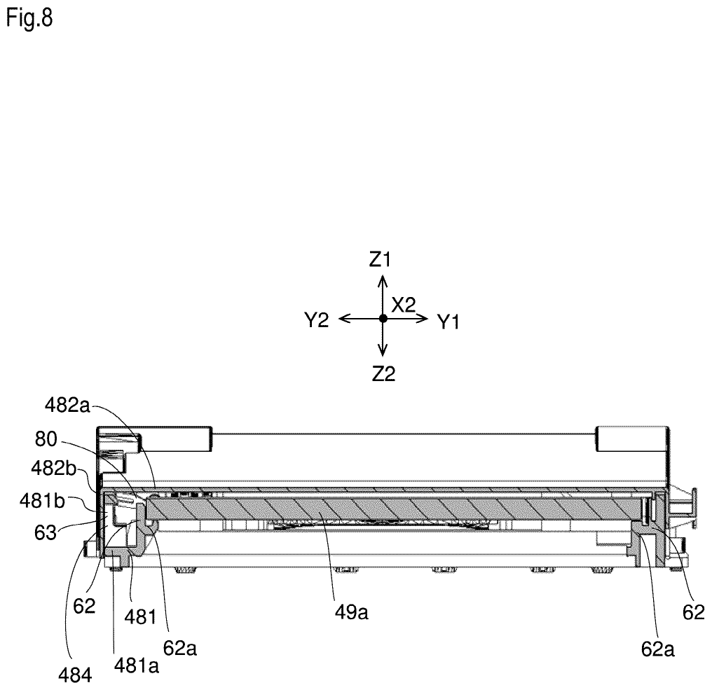

FIG. 7 is a perspective view of a pressing spring 80 (pressing holding member) pressing and holding one reflection mirror 49a, and FIG. 8 is a cross-sectional view taken along line B-B in FIG. 2. FIG. 9 is a partial cross-sectional view illustrating a vicinity of one reflection mirror 49a in an enlarged manner and illustrates a holding structure on one end side (Y2 side) of one reflection mirror 49a in the longitudinal direction.

The holding portion 481 includes mirror holding portions 62 and second spring support portions 63 (see FIG. 8). The mirror holding portions 62 and the second spring support portions 63 protrude upward (in Z1 direction) from the upper surface of the bottom wall portion 481a. The mirror holding portions 62 are disposed at two positions on both end parts of the bottom wall portion 481a in the main scanning direction (Y1-Y2 direction), namely, are provided at four positions in total.

Each of the mirror holding portions 62 includes a protruding holding portion 62a protruding from a side surface in the longitudinal direction (Y1-Y2) direction of the reflection mirrors 49a. The protruding holding portion 62a includes a projection 62b projecting from an upper surface of a front end part. An upper end part of the mirror holding portion 62 faces a side surface of the corresponding reflection mirror 49a in the longitudinal direction (Y1-Y2 direction). The projection 62b faces a lower surface of the corresponding reflection mirror 49a in the top-bottom direction (Z1-Z2 direction).

The second spring support portions 63 are provided at parts of the peripheral wall portion 481b of the housing portion 481 on the Y2 side, and are disposed one pair each at both end parts in the right-left direction (X1-X2 direction). The through hole 484 is provided on the left side X2 of the second spring support portion 63 disposed at the end part on the left side X2. Likewise, the through hole 484 is provided on the right side X1 of the second spring support portion 63 disposed at the end part on the right side X1. Each of the second spring support portions 63 includes a support protrusion 63a. The support protrusions 63a protrude from side surfaces of the respective second spring support portions 63 in a front direction (Y1 direction) (see FIG. 9).

In other words, the casing 48 includes the second spring support portions (support portions) 63. The second spring support portions 63 are provided to face the mirror holding portions 62, and support spring body portions (body portions) 81 of the pressing springs 80 described below. The second spring support portions (support portions) 63 are disposed on peripheral edges of the respective through holes 484 penetrating through the casing 48, and include the support protrusions 63a.

The support protrusions 63a protrude from outer surfaces of the respective second spring support portions (support portions) 63. In the present embodiment, the support protrusions 63a extend in directions approaching the corresponding mirror holding portions 62. At this time, the support protrusions 63a are disposed to face the respective through holes 484.

Front ends of the support protrusions 63a are positioned inside the respective through holes 484 in a cross-section in the right-left direction (X1-X2 direction) orthogonal to the axial direction of the rotation axis J of the polygon mirror 45 and the longitudinal direction (Y1-Y2 direction) of the reflection mirrors 49a included in the scanning optical system.

The both ends of the reflection mirrors 49a in the longitudinal direction (both ends in Y1-Y2 direction) are held by the mirror holding portions 62 (see FIG. 8). More specifically, each of the reflection mirrors 49a is held between the paired mirror holding portions 62 in the longitudinal direction (Y1-Y2 direction), and the lower surfaces of the reflection mirrors 49a are supported by the projections 62b. In addition, one end parts (on Y2 side) of the reflection mirrors 49a in the longitudinal direction are pressed by the pressing springs 80. The pressing springs 80 are supported by the spring support portions 63, and the reflection mirrors 49a are stably held to the housing portion 481.

More specifically, each of the pressing springs (pressing holding members) 80 is formed by bending a metal plate, and includes a spring body portion (body portion) 81, paired third pressing portions (pressing portions) 83, and paired bent support portions 84.

The spring body portion 81 is supported by the corresponding second spring support portion 63 of the casing 48. The paired bent support portions 84 are continuously provided at a lower end part of the spring body portion 81 through sixth bent parts 80f, and extend downward. The bent support portions 84 are substantially parallel to the spring body portion 81. The sixth bent parts 80f are bent on the same side as the extending direction of the third pressing portions 83. The bent support portions 84 are disposed on a step portion 63b protruding from a lower end part of the corresponding second spring support portion 63 to the other side (Y1 side) in the longitudinal direction.

The paired third pressing portions 83 are continuously provided at an upper end part of the spring body portion 81 through fifth bent parts 80c. The paired third pressing portions 83 extend while being inclined downward as separating from the spring body portion 81. The third pressing portions 83 are coupled to the spring body portion 81 so as to be elastically deformable with the fifth bent parts 80e as bending fulcrums. Hemispherical third pressing contacts 83a are provided at front end parts of the third pressing portions 83.

Each of the pressing springs 80 includes slits 85 extending over the upper end part of the spring body portion 81 and the third pressing portions 83.

Each of the pressing springs 80 is inserted between the corresponding reflection mirror 49a and the corresponding second spring support portion 63 in the longitudinal direction (Y1-Y2 direction). The support protrusions 63a abuts on parts between the paired third pressing portions 83 at the upper end of the spring body portions 81 of the respective pressing springs 80. As a result, the pressing springs 80 are easily positioned to the respective second spring support portions 63. The paired third pressing portions 83 are in contact with two upper surfaces on one end side (Y2 side) of the corresponding reflection mirrors 49a in the longitudinal direction at the third pressing contacts 83a.

As a result, the reflection mirrors 49a are pressed against the projections 62b by urging force of the third pressing portions of the respective pressing springs 80. In other words, the third pressing portions (pressing portions) 83 press the reflection mirrors (optical elements) 49a held by the mirror holding portions (holding portions) 62 against the mirror holding portions (holding portions) 62.

With this configuration, each of the reflection mirrors 49a can be held to the corresponding mirror holding portions 62 by using one pressing spring 80. This makes it possible to stably hold the reflection mirrors 49a without increasing the number of pressing springs 80.

When the housing portion 481 is formed by sandwiching a resin with dies in the front-rear direction (Y1-Y2 direction), the through holes 484 can be used as die removing holes. This makes it possible to easily form the support protrusions 63a. Further, the through holes 484 are covered with the peripheral surface portion 482b. Therefore, using the lid portion 482 eliminates necessity for formation of new members covering the through holes 484. Accordingly, it is possible to provide the optical scanning device 5 that can stably hold the reflection mirrors (optical elements) 49a while suppressing increase in manufacturing cost, and the image forming apparatus 100 including the optical scanning device 5.

The front ends of the support protrusions 63a are positioned inside the respective through holes 484 in the cross-section in the right-left direction (X1-X2 direction). Therefore, the support protrusions 63a can be more easily formed by using the through holes 484 as the die removing holes.

Note that the front ends of the support protrusions 63a may be bent in directions approaching the respective through holes 484. As a result, the front ends of the support protrusions 63a can be locked to the upper ends of the respective spring body portions 81. In other words, the support protrusions 63a are locked to the peripheral edges of the respective spring body portions (body portions) 81. Accordingly, the pressing springs 80 are stably supported to the respective second spring support portions (support portions) 63. Even in a case where the front ends of the support protrusions 63a are bent, the support protrusions 63a can be more easily formed by using the through holes 484 as the die removing holes.

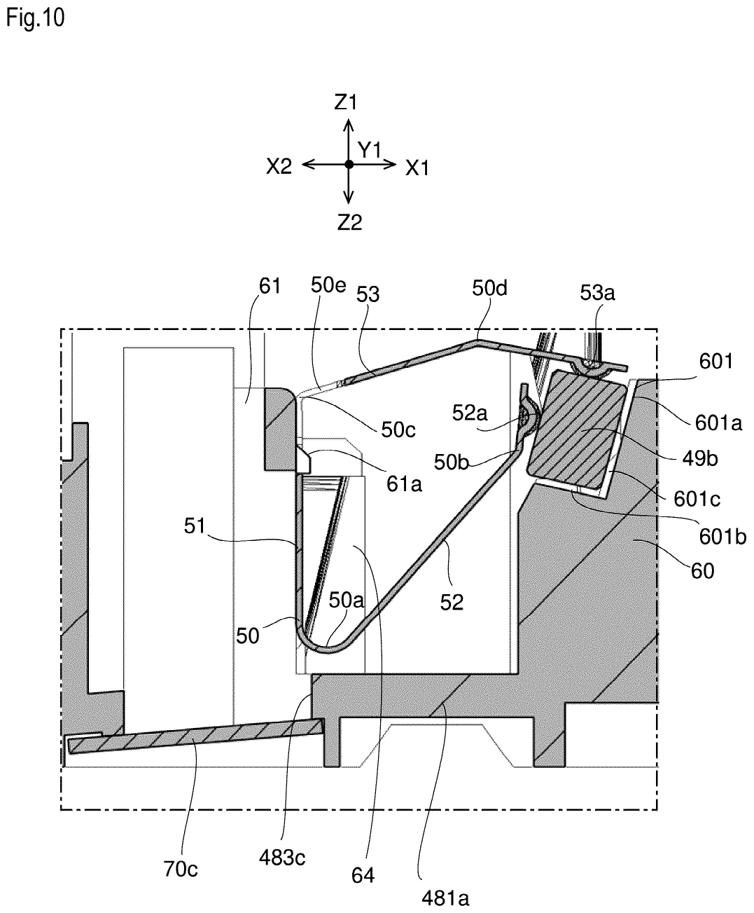

The present disclosure is not limited to the above-described embodiment, and can be variously changed without departing from the gist of the present disclosure. FIG. 10 is a partial cross-sectional view illustrating a modification of the attachment configuration of one reflection mirror 49b. Spring clamping portions (clamping portions) 64 may be provided. At this time, the housing portion 481 further includes the spring clamping portions 64. The spring clamping portions 64 protrudes upward (in Z1 direction) from the upper surface of the bottom wall portion 481a.

The spring clamping portions 64 are disposed to face the corresponding first spring support portions 61 in the right-left direction (X1-X2 direction). Each of the spring body portions 51 is clamped between the corresponding spring clamping portions 64 and the corresponding first spring support portion 61. In the present embodiment, the paired spring clamping portions 64 are disposed so as to sandwich each of the first pressing portions 52. In other words, the casing 48 further includes the spring clamping portions (clamping portions) 64 provided to face the first spring support portions (support portions) 61, and each of the spring body portions (body portions) 51 is clamped between the corresponding first spring support portion (support portion) 61 and the corresponding spring clamping portions (clamping portions) 64. As a result, the pressing springs 50 are more stably supported to the first spring support portions 61, and can be prevented from being rotated and detached.

In the above-described embodiment, the configuration in which the pressing springs 50 and 80 press and hold the reflection mirrors 49a and 49b is described; however, the optical elements pressed and held by the pressing springs 50 and 80 are not limited to the reflection mirrors 49a and 49b, and may be the first scan lenses 41, the second scan lenses 42, or the reflection mirrors 49c.

As the image forming apparatus 100 mounted with the optical scanning device 5, the tandem color printer is described as an example; however, the present disclosure is not limited to the color printer, and is applicable to an electrophotographic color image forming apparatus such as a color copier and a facsimile, and an electrophotographic monochrome image forming apparatus such as a monochrome printer and a monochrome multifunctional peripheral.

The present disclosure is usable for an optical scanning device forming a latent image on a scanned surface by exposure scanning.

What is claimed is:

1. An optical scanning device exposing a surface of an image carrier to form an electrostatic latent image having attenuated charges, the optical scanning device comprising:
a scanning optical system configured to perform scanning with a laser beam and to guide the laser beam to the image carrier;
a casing configured to house the scanning optical system, and including a holding portion holding an optical element configuring the scanning optical system; and
a pressing holding member configured to press and hold the optical element to the holding portion, wherein
the pressing holding member includes a body portion, and a pressing portion coupled to the body portion and pressing the optical element held by the holding portion, against the holding portion,
the casing includes a support portion provided to face the holding portion and supporting the body portion,
the support portion is disposed on a peripheral edge of a through hole penetrating through the casing, and includes a support protrusion protruding from an outer surface to come into contact with a peripheral edge of the body portion, and
the through hole is an emission port emitting the laser beam to outside of the casing.

2. The optical scanning device according to claim 1, wherein
the optical element is a reflection mirror reflecting the laser beam, and
the support protrusion includes a front end positioned inside the through hole in a cross-section orthogonal to a longitudinal direction of the reflection mirror.

3. The optical scanning device according to claim 1, wherein
the support protrusion extends in a direction approaching the holding portion, and
the support protrusion includes a front end bent in a direction approaching the through hole.

4. The optical scanning device according to claim 1, wherein
the casing further includes a clamping portion provided to face the support portion, and
the body portion is clamped between the support portion and the clamping portion.

5. An optical scanning device exposing a surface of an image carrier to form an electrostatic latent image having attenuated charges, the optical scanning device comprising:
a scanning optical system configured to perform scanning with a laser beam and to guide the laser beam to the image carrier;
a casing configured to house the scanning optical system, and including a holding portion holding an optical element configuring the scanning optical system; and
a pressing holding member configured to press and hold the optical element to the holding portion, wherein
the pressing holding member includes a body portion, and a pressing portion coupled to the body portion and pressing the optical element held by the holding portion, against the holding portion,
the casing includes a support portion provided to face the holding portion and supporting the body portion,
the support portion is disposed on a peripheral edge of a through hole penetrating through the casing, and includes a support protrusion protruding from an outer surface to come into contact with a peripheral edge of the body portion,
the casing includes a housing portion including an opened upper surface and housing the scanning optical system, and a lid portion covering the upper surface of the housing portion,
each of the housing portion and the lid portion includes a wall portion surrounding the scanning optical system from sides, and
the through hole is provided on the wall portion of one of the housing portion and the lid portion, and is closed by the wall portion of another of the housing portion and the lid portion.

6. The optical scanning device according to claim 5, wherein
the optical element is a reflection mirror reflecting the laser beam, and
the support protrusion includes a front end positioned inside the through hole in a cross-section in a direction orthogonal to an axis direction of a rotation axis of a polygon mirror and a longitudinal direction of the reflection mirror included in the scanning optical system.

7. The optical scanning device according to claim 5, wherein
the support protrusion extends in a direction approaching the holding portion, and
the support protrusion includes a front end bent in a direction approaching the through hole.

8. An image forming apparatus, comprising:
one or more image carriers each including a photosensitive layer on a surface;
a charging device configured to charge the image carriers to a predetermined surface potential; and
the optical scanning device according to claim 1, configured to expose the surfaces of the image carriers charged by the charging device to form electrostatic latent images having attenuated charges.
